(19) United States
(12) Patent Application Publication
(10) Pub. No.: US 2016/0041752 A1
(43) Pub. Date: Feb. 11, 2016

(54) INFORMATION PROCESSING DEVICE, INFORMATION PROCESSING METHOD, AND INFORMATION PROCESSING SYSTEM

(71) Applicant: FUJITSU LIMITED, Kawasaki-shi (JP)

(72) Inventors: Shinya Kimura, Sapporo (JP); Yusuke Iwaki, Sapporo (JP)

(21) Appl. No.: 14/728,449

(22) Filed: Jun. 2, 2015

(30) Foreign Application Priority Data
Aug. 8, 2014 (JP) 2014-163034

(51) Int. Cl. G06F 3/0488; G06F 3/041

(52) U.S. Cl. CPC G06F 3/04886; G06F 3/0418; G06F 2203/04101

(57) ABSTRACT

An information processing device includes: a processor configured to execute a program read from a storage device, wherein the processor, based on the program, performs operations to: display, on a touch panel, first keys each having a first display position of a character; acquire a first input position for the touch panel; display, on the touch panel, a first character assigned to a first proximate key near the first input position, among the first keys; and update the first character displayed on the touch panel by using a second character assigned to a second proximate key near the first input position among second keys each having a second display position of the character.

### CROSS-REFERENCE TO RELATED APPLICATION

This application is based upon and claims the benefit of priority of the prior Japanese Patent Application No. 2014-163034, filed on Aug. 8, 2014, the entire contents of which are incorporated herein by reference.

### FIELD

The embodiment discussed herein is related to an information processing device, an information processing method, and an information processing system.

### BACKGROUND

Information processing devices such as smart phones and tablets include a function of inputting a character assigned to each of a plurality of keys displayed on a touch panel. The user of an information processing device places a finger on any one of a plurality of keys displayed on a touch panel and thus inputs a character assigned to the key on which the finger is placed.

Related techniques are disclosed in Japanese Laid-open Patent Publication No. 2004-54589, Japanese National Publication of International Patent Application No. 2009-522669, and Japanese Laid-open Patent Publication No. 2013-58081.

### SUMMARY

According to an aspect of the embodiments, an information processing device includes: a processor configured to execute a program read from a storage device, wherein the processor, based on the program, performs operations to: display, on a touch panel, first keys each having a first display position of a character; acquire a first input position for the touch panel; display, on the touch panel, a first character assigned to a first proximate key near the first input position, among the first keys; and update the first character displayed on the touch panel by using a second character assigned to a second proximate key near the first input position among second keys each having a second display position of the character.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A to 1H illustrate an example of transition of a display screen of a touch panel;

FIG. 2 illustrates an example of a configuration of an information processing device;

FIG. 3 illustrates an example of a key display position table;

FIG. 4 illustrates an example of an input position table;

FIG. 5 illustrates an example of a functional configuration of a processor;

FIG. 6 illustrates an example of detection of a hover-in state and a hover-out state;

FIG. 7 illustrates an example of a key change operation;

FIG. 8 illustrates an example of a key change operation;

FIG. 9 illustrates an example of a key change operation;

FIG. 10 illustrates an example of extraction of keys near a plurality of input positions;

FIG. 11 illustrates the example of extraction of keys near a plurality of input positions;

FIG. 12 illustrates an example of update of character strings;

FIGS. 13A and 13B illustrate an example of a process of an information processing device; and

FIG. 14 illustrates an example of an information processing device.

### DESCRIPTION OF EMBODIMENT

The size of a finger or hand placed on a key varies depending on the user, and therefore the display position of the key is adjusted in accordance with the size of a hand of the user. For example, the size of a keyboard itself including the key may be adjusted. For example, the key layout of a keyboard may be determined so as to coincide a center of a specific key with a position at which a finger touches the touch panel, and the determined key layout may be displayed on the touch panel.

Even when the display positions of keys are adjusted, the display positions of keys are fixed at the time of inputting a character. The user of an information processing device places a finger on any one of a plurality of keys while being aware of the display position of the key. For this reason, a burden of placing the finger on the display position of a key may be imposed on the user.

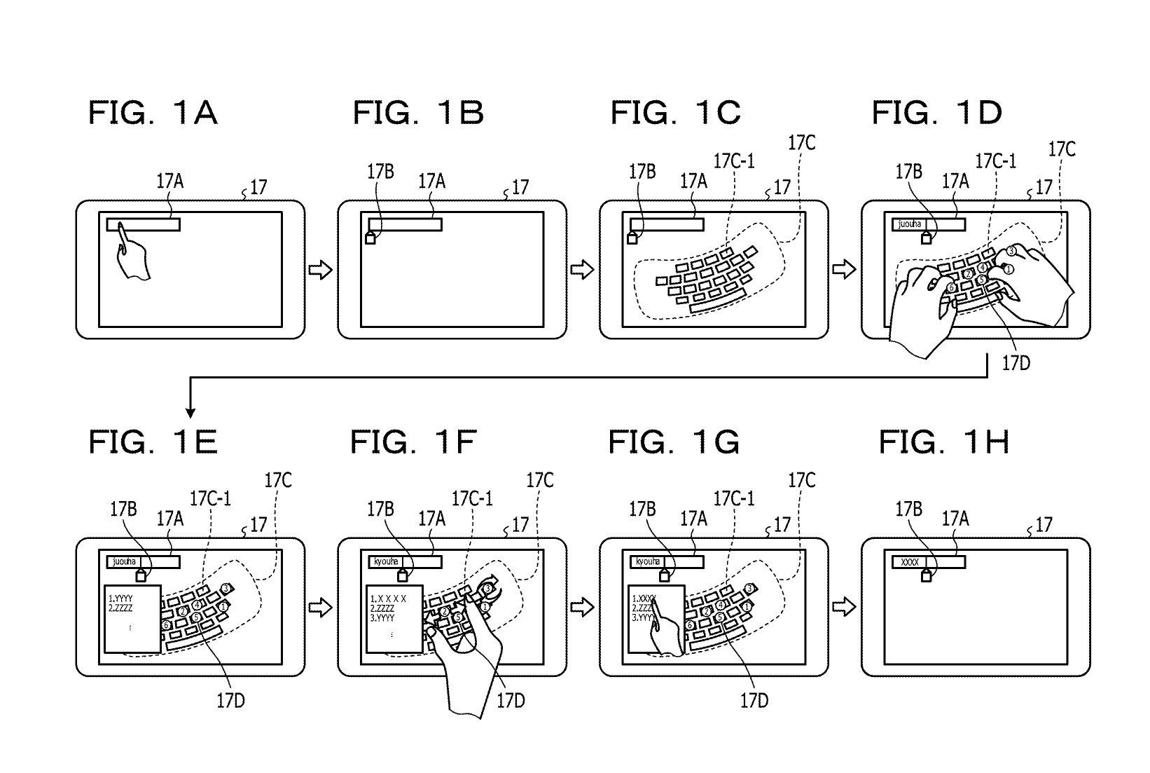

FIGS. 1A to 1H illustrate an example of transition of display screens of a touch panel. FIG. 1A is a display screen in a normal mode in which input of a character into a character input area is not accepted. FIG. 1B is a display screen in a character input mode in which input of a character into the character input area is accepted. FIG. 1C is a display screen in a state in which a plurality of keys to which characters are assigned are displayed. FIG. 1D is a display screen in a state in which input position markers for visualizing input positions for a touch panel are displayed. FIG. 1E is a display screen in a state in which first characters assigned to keys near the input positions are displayed. FIG. 1F is a display screen in a state in which, after an operation of changing the display positions of a plurality of keys is carried out, second characters assigned to keys near the input positions are displayed. FIG. 1G is a display screen in a state in which characters are selected. FIG. 1H is a display screen in a state in which the selected characters are displayed in the character input area. For example, in FIGS. 1A to 1H, the user of the information processing device may input characters “XXXX” on the touch panel 17.

As illustrated in FIG. 1A, the user of the information processing device taps on a character input area 17A displayed on the touch panel 17 in the normal mode. The normal mode is switched to a character input mode. In the character input area 17A displayed on the touch panel 17, as illustrated in FIG. 1B, a character input cursor 17B is displayed.

In such a situation, the information processing device, as illustrated in FIG. 1C, displays a plurality of keys 17C-1 on the touch panel 17. Characters are assigned to the plurality of keys 17C-1, respectively. The information processing device displays the plurality of keys 17C-1, as a keyboard 17C, on the touch panel 17.

The information processing device acquires an input position for the touch panel 17 when a touch event occurs on the touch panel 17. The information processing device sequentially acquires a plurality of input positions for the touch panel 17 when a plurality of touch events on the touch panel 17 successively occur. The information processing device, upon acquiring the input positions, displays input position markers 17D for visualizing the acquired input positions, on the touch panel 17, as illustrated in FIG. 1D. When the plurality of input positions for the touch panel 17 are sequentially acquired, the information processing device displays a plurality of input position markers 17D, in association with the positions in the order in which the plurality of input positions are acquired (hereinafter referred to as “input order”), on the touch panel 17. For example, when six input positions are sequentially acquired, the information processing device displays, on the touch panel 17, the plurality of input position markers 17D indicating that the positions of the input order are first, “1”, to sixth, “6”, positions, respectively.

The information processing device, as illustrated in FIG. 1E, displays first characters assigned to keys near the input positions, out of the plurality of keys 17C-1 displayed on the touch panel 17. The keys near the input positions are a predetermined number of keys extracted, in increasing order from the smallest distance to the input position, from the plurality of keys 17C-1 displayed on the touch panel 17. When a plurality of input positions for the touch panel 17 are sequentially acquired, the information processing device may perform processing of displaying first characters as described below. For example, the information processing device displays, on the touch panel 17, a first character string obtained by arranging, in the input order, first characters assigned to keys respectively near a plurality of input positions. The first character includes conversion candidate character corresponding to the first character, and the first character string includes conversion candidate character string corresponding to the first character string. For example, it is assumed that first character strings, which are each obtained by sequentially acquiring six input positions and arranging, in the input order, first characters assigned to keys respectively near the six input positions, are “juouha” and “kuouja”. In this case, a conversion candidate character string “YYYY” corresponding to “juouha” and a conversion candidate character string “ZZZZ” corresponding to “kuouja” are displayed on the touch panel 17.

When a multi-touch event has occurred on the touch panel 17, the information processing device accepts an operation of changing the display positions of the plurality of keys 17C-1 as illustrated in FIG. 1F. Examples of the operation of changing the display positions of the plurality of keys 17C-1 may include an operation of moving a plurality of keys, an operation of enlarging the sizes of a plurality of keys, an operation of reducing the sizes of a plurality of keys, an operation of rotating a plurality of keys, and an operation of changing the curvatures of a plurality of keys. The operation of changing the display positions of the plurality of keys 17C-1 may be referred to as a “key change operation” as appropriate hereinafter.

When the key change operation is accepted, as illustrated in FIG. 1F, the information processing device updates the first characters displayed on the touch panel 17 by using second characters assigned to keys near the input positions, out of the plurality of keys 17C-1 for which the display positions have been changed by the key change operation. When a plurality of input positions for the touch panel 17 are sequentially acquired, the information processing device performs a character update process as described below. For example, the information processing device updates a first character string displayed on the touch panel 17 with a second character string obtained by arranging, in the input order, second characters assigned to keys respectively near the plurality of input positions, out of the plurality of keys 17C-1 the display positions of which have been changed. The second characters include conversion candidate characters corresponding to the second characters, and the second character string includes second conversion candidate character string for the second character string. For example, it is assumed that second character strings each obtained by acquiring six input positions sequentially and arranging, in the input order, second characters assigned to keys respectively near the six input positions are “kyouha”, “juouha”, and “kouja”. In this case, the first character string displayed on the touch panel 17 is updated with “XXXX”, which is a conversion candidate character string corresponding to “kyouha”, “YYYY”, which is a conversion candidate character string corresponding to “juouha”, and “ZZZZ”, which is a conversion candidate character string corresponding to “kuouja”.

The user of the information processing device, as illustrated in FIG. 1G, selects “XXXX”, which is a character string whose characters are to be input, out of the updated first character strings. As illustrated in FIG. 1H, display of the keyboard 17C is stopped, and “XXXX”, which is the selected character string, is displayed in the character input area 17A. Tapping on an area other than the character input area 17A in the touch panel 17 switches the character input mode to the normal mode.

In such a way, in the information processing device, first characters assigned to keys near input positions are displayed on the touch panel. The first characters are updated by using second characters assigned to keys near the input positions out of a plurality of keys the display positions of which have been changed by the key change operation. This excludes a motion in which the user of the information processing device places a finger on any one of a plurality of keys while being aware of the display position of the key. In the information processing device, character input may be performed without imposing the burden of placing the finger on the display position of a key on a user.

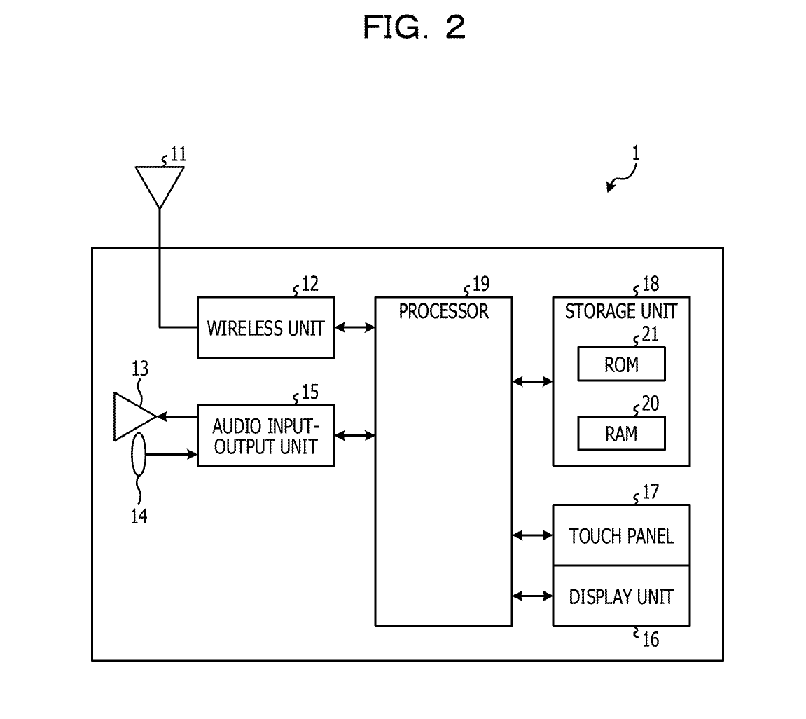

FIG. 2 illustrates an example of a configuration of an information processing device. An information processing device 1 illustrated in FIG. 2 may be, for example, an information processing device such as a tablet having a touch panel function that accepts a touch event of the user. The information processing device 1 includes an antenna 11, a wireless unit 12, a speaker 13, a microphone 14, an audio input-output unit 15, a display unit 16, and a touch panel 17. The information processing device 1 includes a storage unit 18 and a processor 19. The storage unit 18 includes a random access memory (RAM) 20 and a read only memory (ROM) 21.

The wireless unit 12 transmits and receives radio signals through the antenna 11. The audio input-output unit 15 performs audio processing on sounds collected by the microphone 14, performs audio processing on sound signals within radio signals received through the wireless unit 12, and provides sound output from the speaker 13. The display unit 16 may be an output interface that displays, on the screen, various kinds of information such as display screens for the character input mode. The touch panel 17 may be an input interface that detects touch operations and the like on the screen of the display unit 16. Hereinbelow, the display unit 16 and the touch panel 17 may be collectively represented as the “touch panel 17”.

The RAM 20 may be a memory area in which various kinds of information are stored. In the RAM 20, a key display position table 81 and an input position table 82 are stored. In the ROM 21, various programs such as information processing programs are stored. The processor 19 controls the entire information processing device 1.

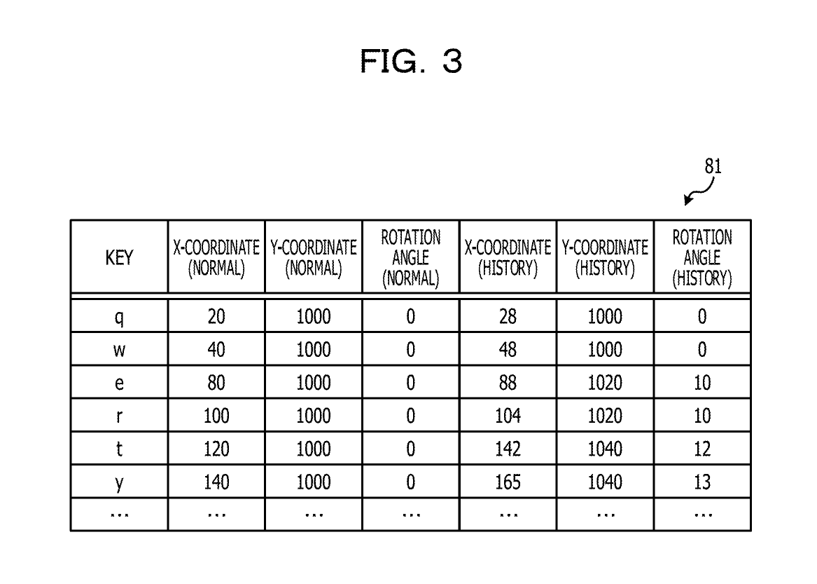

FIG. 3 depicts an example of a key display position table. A key display position table 81 depicted in FIG. 3 manages a key, an x-coordinate (normal), a y-coordinate (normal), a rotation angle (normal), an x-coordinate (history), a y-coordinate (history), and a rotation angle (history) in association with one another. The key is one of a plurality of keys to which characters are assigned. The x-coordinate (normal) is the initial value of the x-coordinate of a display position of each key. The y-coordinate (normal) is the initial value of the y-coordinate of a display position of each key. The rotation angle (normal) is the initial value of a rotation angle used for changing the curvature of each key. The x-coordinate (history) is the x-coordinate of a display position of each key changed by a key change operation. The y-coordinate (history) is the y-coordinate of a display position of each key changed by a key change operation. The rotation angle (history) is a rotation angle after the curvature of each key is changed by a key change operation. The x-coordinate (history), the y-coordinate (history), and the rotation angle (history) are updated as history data each time a key change operation is accepted. For example, the history data indicates the display position changed by a key change operation.

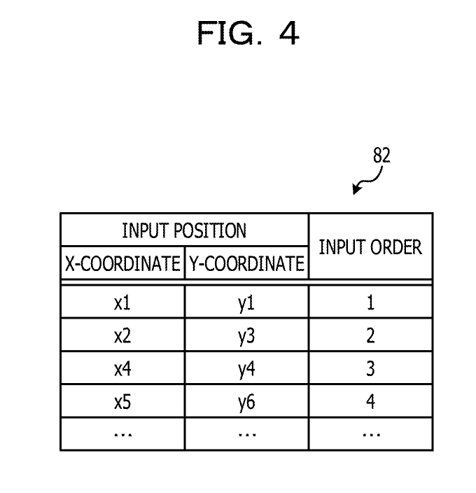

FIG. 4 depicts an example of an input position table. An input position table 82 depicted in FIG. 4 manages an input position/x-coordinate, an input position/y-coordinate, and the input order in association with one another. The input position/x-coordinate is the x-coordinate of an input position for the touch panel 17. The input position/y-coordinate is the y-coordinate of an input position for the touch panel 17. The input order is the order in which, when a plurality of input positions for the touch panel 17 are sequentially acquired, the plurality of input positions are acquired.

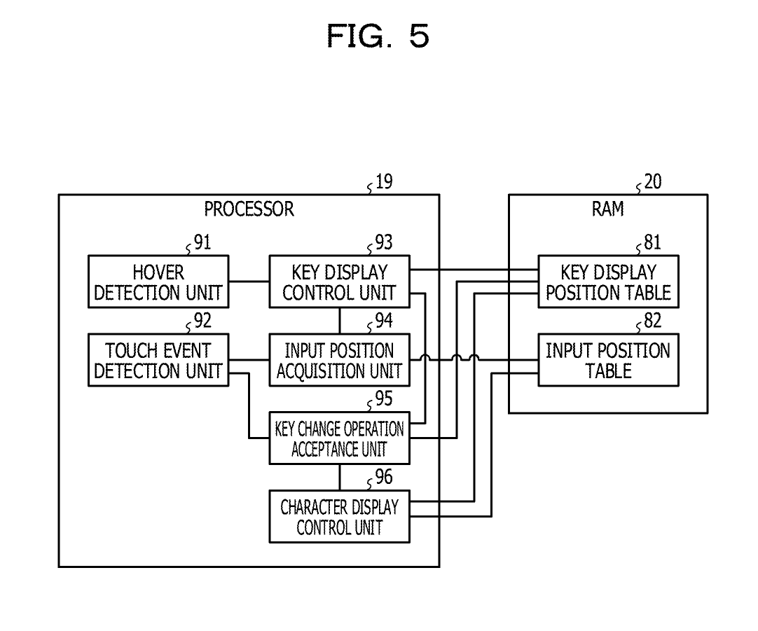

FIG. 5 illustrates an example of a functional configuration of a processor. A processor 19 illustrated in FIG. 5 reads an information processing program stored in the ROM 21 and executes various processes based on the read information processing program. The processor 19 includes, as the functional configuration, a hover detection unit 91, a touch event detection unit 92, a key display control unit 93, an input position acquisition unit 94, a key change operation acceptance unit 95, and a character display control unit 96.

The hover detection unit 91 detects a hover-in state in which a finger of the user using the information processing device 1 is near the touch panel 17. The hover detection unit 91 detects a hover-out state in which a finger of the user using the information processing device 1 is away from the touch panel 17.

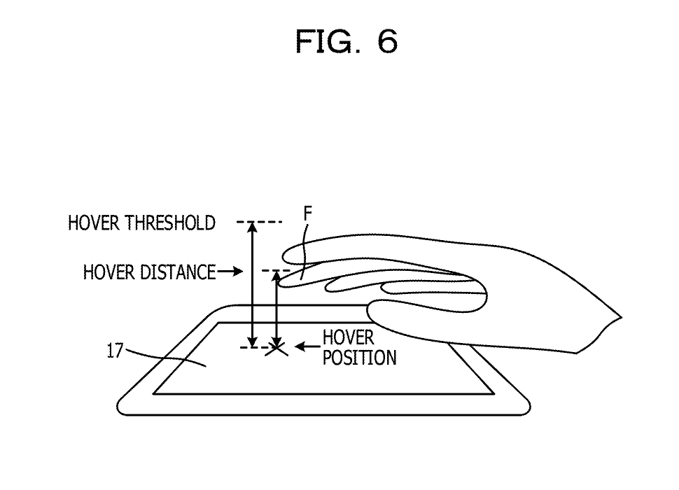

FIG. 6 illustrates an example of detection of a hover-in state and a hover-out state. As illustrated in FIG. 6, the hover detection unit 91 detects a finger F of the user using the information processing device 1, a hover distance, which is a distance to the surface of the touch panel 17, and a hover position, which is the position of the finger F on the touch panel 17. The hover detection unit 91 determines whether or not the hover distance is larger than or equal to a hover threshold. The hover threshold may be predetermined so as to enable the touch panel 17 to successively detect the finger F for a given period of time. When the hover distance exceeds the hover threshold, the hover detection unit 91 discards the hover position and does not detect the hover-in state. When the hover distance is less than or equal to the hover threshold, the hover detection unit 91 outputs the hover position to the key display control unit 93 and detects the hover-in state. The hover-in detection unit 91, after detecting the hover-in state, determines whether or not the hover distance is less than or equal to the hover threshold, and detects a hover-out state when the hover distance exceeds the hover threshold.

The touch event detection unit 92 illustrated in FIG. 5 detects a touch event on the touch panel 17. When a plurality of touch events on the touch panel 17 are successively detected, the touch detection unit 92 sequentially detects the coordinates of the contact position of a finger on the touch panel 17, and sequentially outputs the detected coordinates to the input position acquisition unit 94. When a multi-touch event on the touch panel 17 is detected, the touch event detection unit 92 substantially simultaneously detects the coordinates of contact positions of a plurality of fingers on the touch panel 17, and outputs the detected coordinates to the key change operation acceptance unit 95.

The key display control unit 93 displays a plurality of keys to which characters are assigned, on the touch panel 17. For example, the key display control unit 93 displays a plurality of keys on the touch panel 17 when a hover-in state is detected by the hover detection unit 91.

When a hover-in state is detected and a key change operation is not accepted by the key change operation acceptance unit 95, the key display control unit 93 displays a plurality of keys at display positions determined by using the position of a finger on the touch panel 17. For example, the key display control unit 93 receives a hover position indicating the position of a finger on the touch panel 17, from the hover detection unit 91. The key display control unit 93 refers to the key display position table 81 and determines whether or not there is history data. When there is no history data, the key display control unit 93 computes a difference amount between the initial value of the display position of a specific key and the hover position. The key display control unit 93 displays a plurality of keys at display positions each of which is determined by adding the computed difference amount to the initial value of the display position of each key.

When a hover-in state is detected and a key change operation is accepted by the key change operation acceptance unit 95, the key display control unit 93 displays a plurality of keys at display positions changed by the key change operation. For example, the key display control unit 93 refers to the key display position table 81, acquires history data indicating display positions changed by the key change operation, and displays the plurality of keys at the display positions indicated by the history data.

After displaying the plurality of keys on the touch panel 17, the key display control unit 93 stops display of the plurality of keys when the hover-out state is detected by the hover detection unit 91 and an input position is not acquired by the input position acquisition unit 94.

The input position acquisition unit 94 acquires an input position for the touch panel 17. For example, the input position acquisition unit 94 acquires an input position using coordinates input from the touch event detection unit 92. When a plurality of touch events on the touch panel 17 successively occur, the input position acquisition unit 94 sequentially acquires a plurality of input positions for the touch panel 17 using coordinates input from the touch event detection unit 92. The input position acquisition unit 94 stores the plurality of input positions acquired, in association with the input order, in the input position table 82.

The input position acquisition unit 94 displays an input position marker for visualizing an acquired input position, on the touch panel 17. When a plurality of input positions are sequentially acquired, the input position acquisition unit 94 displays a plurality of input position markers in association with the input order, on the touch panel 17.

The key change operation acceptance unit 95 accepts an operation of changing the display positions of a plurality of keys, for example, a key change operation. For example, the key change operation acceptance unit 95 accepts a key change operation using coordinates input from the touch event detection unit 92, and stores a display position changed by the key change operation, as history data, in the key display position table 81. The key change operation acceptance unit 95 notifies the character display control unit 96 that the key change operation has been accepted.

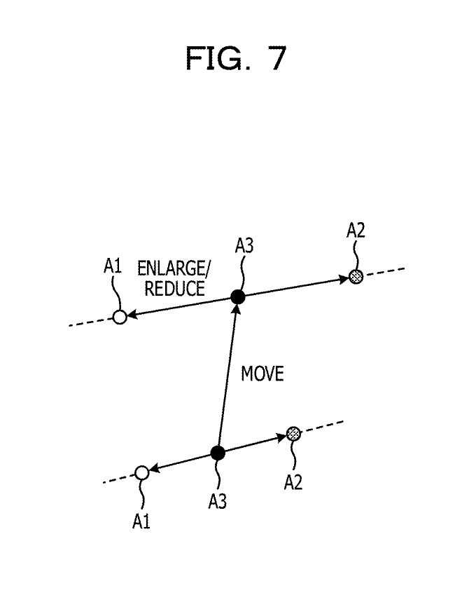

FIG. 7 illustrates an example of a key change operation. In FIG. 7, for example, coordinates input from the touch event detection unit 92 may correspond to the coordinates of contact positions of two fingers on the touch panel 17. In the key change operation illustrated in FIG. 7, when the center A3 of a line coupling two points A1 and A2, which correspond to the contact positions of two fingers, respectively, moves, the movement amount of the center A3 is acquired. Moving a plurality of keys using the acquired movement amount results in a change of the display positions of the plurality of keys. In the key change operation illustrated in FIG. 7, when the length of a line coupling the two points A1 and A3 is increased or decreased, the factor by which the length is increased or decreased from the original length is obtained. Enlarging or reducing a plurality of keys by the obtained factor results in a change of the display positions of the plurality of keys.

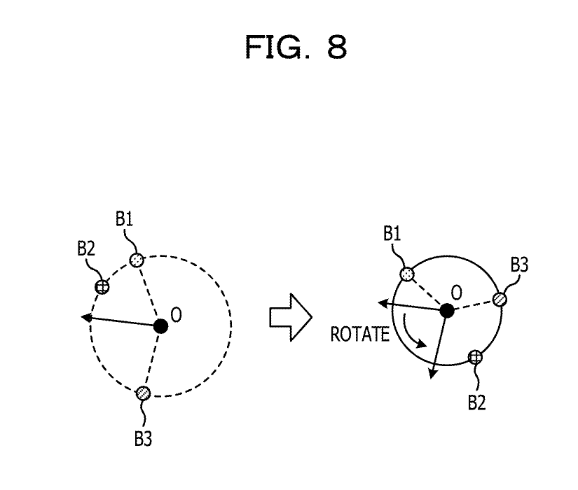

FIG. 8 illustrates an example of the key change operation. In FIG. 8, for example, the coordinates input from the touch event detection unit 92 may correspond to the coordinates of contact positions of three fingers on the touch panel 17. In the key change operation illustrated in FIG. 8, assuming that the center of a circle passing through three points B1 to B3, which correspond to contact positions of three fingers, respectively, is a point 0, rotating a plurality of keys by using the rotation amount of a vector from the point 0 toward the center of a circular arc coupling three points B1 to B3 results in a change of the display positions of the plurality of keys.

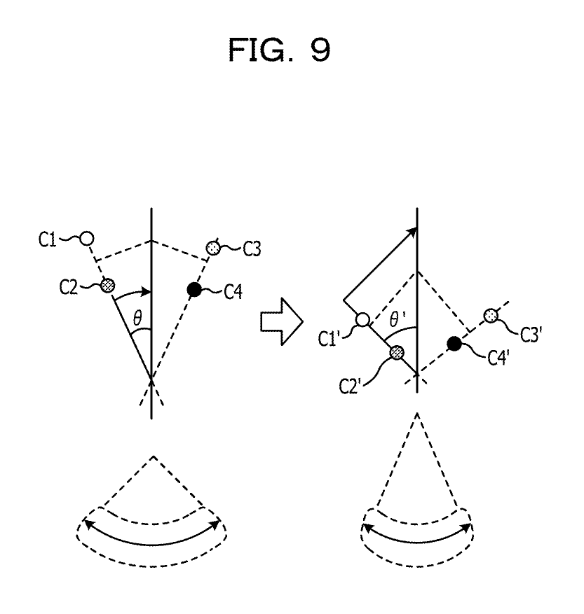

FIG. 9 illustrates an example of the key change operation. In FIG. 9, for example, the coordinates input by the touch event detection unit 92 may correspond to the coordinates of contact positions of four fingers on the touch panel 17. In the key change operation illustrated in FIG. 9, the display positions of a plurality of keys are changed by changing the curvatures of the plurality of keys using a tangent value of half the angle formed by a straight line passing through two points on the left side, out of four points C1 to C4 corresponding to the contact positions of four fingers, respectively, and a straight line passing through two points on the right side.

When input position markers are displayed on the touch panel 17, the key change operation acceptance unit 95 may accept a key change operation with a state in which the input position markers are displayed on the touch panel 17. For example, the key change operation acceptance unit 95 may accept a key change operation so that, with a state in which input position markers are displayed on the touch panel 17, keys to which characters to be input are assigned becomes near the input position markers.

The character display control unit 96 displays, on the touch panel 17, first characters assigned to keys near input positions, out of a plurality of keys displayed on the touch panel 17. For example, the character display control unit 96 refers to the key display position table 81 and the input position table 82, extracts keys near input positions, and displays first characters assigned to the extracted keys on the touch panel 17. When a key change operation is accepted, the character display control unit 96 updates the first characters displayed on the touch panel 17 by using second characters assigned to keys near the input positions, out of a plurality of keys the display positions of which have been changed by the key change operation. For example, the character display control unit 96 refers to the key display position table 81 and the input position table 82, extracts keys near input positions, and updates first characters by using second characters assigned to the extracted keys. The keys near the input positions may be keys which are extracted, by a certain number in increasing order from the smallest distance to the input position, from a plurality of keys displayed on the touch panel 17. The first characters and the second characters include conversion candidate characters corresponding to the first characters and conversion candidate characters corresponding to the second characters.

When a plurality of input positions for the touch panel 17 are sequentially acquired, the character display control unit 96 displays, on the touch panel 17, a first character string obtained by arranging, in the input order, first characters assigned to keys respectively near the plurality of input positions. For example, the character display control unit 96 refers to the key display position table 81 and the input position table 82 and extracts a key near each of a plurality of input positions. A first character string obtained by arranging, in the input order, first characters assigned to the extracted keys is displayed. When a key change operation is accepted, the character display control unit 96 performs the following processing. For example, the character display control unit 96 updates the first character string by using a second character string obtained by arranging, in the input order, second characters assigned to keys respectively near a plurality of input positions the display positions of which have been changed by a key change operation. For example, the character display control unit 96 refers to the key display position table 81 and the input position table 82 and extracts a key near each of a plurality of input positions. A first character string is updated by using a second character string obtained by arranging second characters assigned to the keys in the input order. The first character string and the second character string include a conversion candidate character string corresponding to the first character string and a conversion candidate character string corresponding to the second character string.

When a plurality of first character strings or a plurality of second character strings are obtained, the character display control unit 96 performs the following processing. For example, the character display control unit 96 displays the plurality of first character strings or the plurality of second character strings on the touch panel 17 in such a display manner that a first character string or a second character string for which the sum of distances between a plurality of input positions and keys respectively near the plurality of input positions is smaller is more preferentially selected.

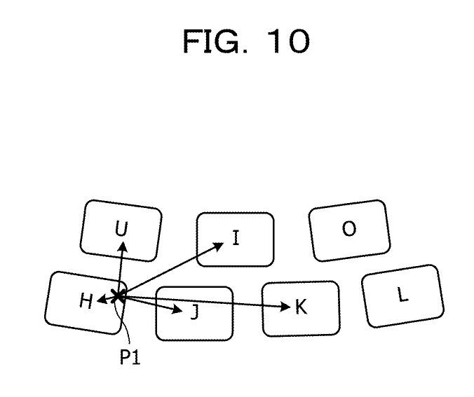

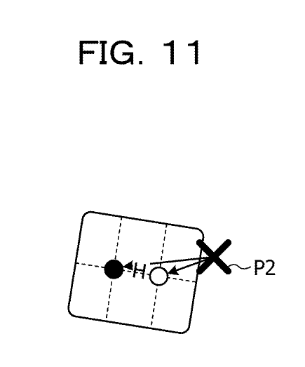

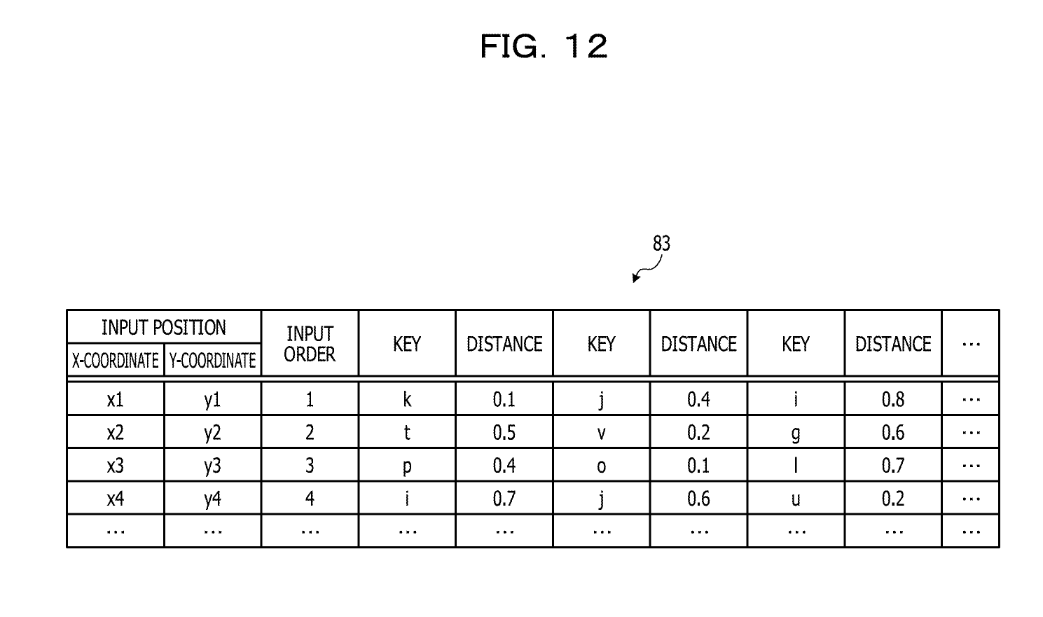

FIG. 10 and FIG. 11 illustrate an example of extraction of keys near a plurality of input positions. FIG. 12 depicts an example of update of character strings. In FIG. 12, update of character strings in the case where a plurality of first character strings or a plurality of second character strings are obtained is depicted. In conjunction with FIG. 12, a key change operation is accepted by the key change operation acceptance unit 95.

The character display control unit 96 accepts, from the key change operation acceptance unit 95, notification that a key change operation has been accepted. The character display control unit 96 refers to the key display position table 81 and the input position table 82 and determines a distance between each of a plurality of input positions and the display position of each key changed by the key change operation. Using the determined distance, the character display control unit 96 extracts a key near each of the plurality of input positions. In FIG. 10, the character display control unit 96 determines the distance between an input position P1 and the center of each key changed by the key change operation. The character display control unit 96 identifies a certain number of keys, in increasing order from the smallest distance to the input position, and thus extracts the keys near the input position P1. In FIG. 11, the character display control unit 96 determines the distances between an input position P2 and two points other than the center of each key changed by the key change operation. The character display control unit 96 identifies a certain number of keys in increasing order from the smallest sum of determined distances, and thus extracts the keys near the input position P2.

The character display control unit 96 adds a character assigned to a key near each of a plurality of input positions and the distance between the display position of the key and each of the plurality of input positions, to the input position table 82, thereby generating a character string update table 83 as depicted in FIG. 12.

The character display control unit 96 refers to the character string update table 83 and updates a first character string displayed on the touch panel 17 by using a second character string obtained by arranging, in the input order, second characters assigned to keys respectively near a plurality of input positions. When a plurality of second character strings are obtained, the character display control unit 96 may display the plurality of second character strings on the touch panel 17 in such a display manner that a second character string for which the sum of distances between a plurality of input positions and keys respectively near the plurality of input positions is smaller is more preferentially selected. In FIG. 12, the character display control unit 96 may display a plurality of second character strings in the order of “kvou . . . ”, “jtpj . . . ” and “igli . . . ” on the touch panel 17.

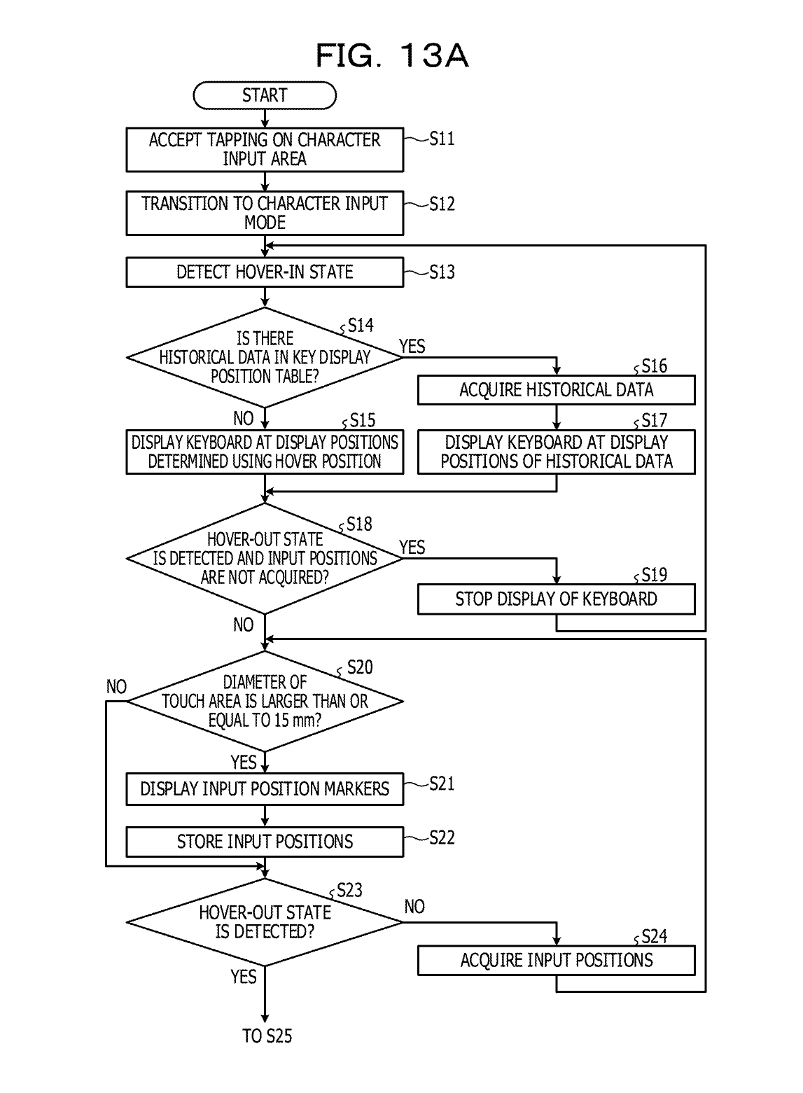

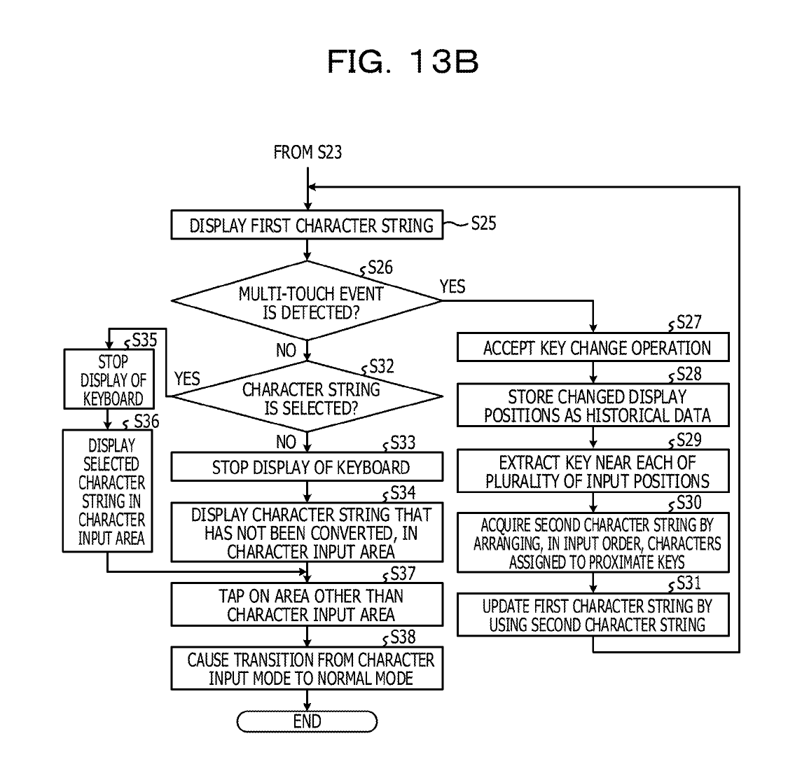

FIGS. 13A and FIG. 13B illustrate an example of a process of an information processing device.

In FIG. 13A, the processor 19 accepts tapping on the character input area 17A displayed on the touch panel 17 (operation S11), and causes the normal mode to transition to the character input mode (operation S12).

The processor 19 detects a hover-in state (operation S13), and, when the hover-in state is detected, refers to the key display position table 81 and determines whether or not there is historical data (operation S14). When there is no historical data (operation S14; No), for example, when a key change operation is not accepted, the processor 19 displays a plurality of keys at display positions determined using the hover position (operation S15).

When there is historical data (operation S14; Yes), for example, when a key change operation is accepted, the processor 19 acquires historical data from the key display position table 81 (operation S16). The processor 19 displays a plurality of keys at display positions indicated by the acquired historical data (operation S17).

When a hover-out state is detected and input positions are not acquired (operation S18; Yes), the processor 19 stops display of the plurality of keys (operation S19). The process returns to operation S13.

When a hover-out state is not detected or when input positions are not acquired (operation S18; No), the processor 19 determines whether or not the diameter of a touch area of a finger for the touch panel 17 is larger than or equal to 15 mm (operation S20). When the diameter of the touch area is less than 15 mm (operation S20; No), the process proceeds to operation S23.

When the diameter of the touch area is larger than or equal to 15 mm (operation S20; Yes), the processor 19 displays input position markers on the touch panel 17 (operation S21) and stores input positions in association with the input order in the input position table 82 (operation S22).

The processor 19 detects a hover-out state (operation S23). When a hover-out state is not detected (operation S23; No), the processor 19 acquires new input positions (operation S24). The process returns to operation S20.

When a hover-out state is detected (operation S23; Yes), the processor 19 displays, on the touch panel 17, a first character string obtained by arranging, in the input order, first characters assigned to keys respectively near the plurality of input positions (operation S25).

When a multi-touch event is detected (operation S26; Yes), in a state in which input position markers are displayed, the processor 19 accepts a key change operation using the coordinates of contact positions of a plurality of fingers for the touch panel 17 (operation S27). The processor 19 stores display positions changed by the key change operation, as historical data, in the key display position table 81 (operation S28).

The processor 19 refers to the key display position table 81 and the input position table 82 and extracts a key near each of the plurality of input positions (operation S29). The processor 19 acquires a second character string by arranging, in the input order, second characters assigned to keys respectively near the plurality of input positions (operation S30). The processor 19 updates the first character string displayed on the touch panel 17 by using the second character string (operation S31). The process returns to operation S25.

When a multi-touch event is not detected (operation S26; No), the processor 19 determines whether or not a character string displayed on the touch panel 17, for example, a first character string or a second character string is selected by the user (operation S32). When the character string displayed on the touch panel 17 is not selected by the user (operation S32; No), the processor 19 stops display of the plurality of keys (operation S33), and displays a character string that has not been converted, in the character input area 17A (operation S34).

When the character string displayed on the touch panel 17 is selected by the user (operation S32; Yes), the processor 19 stops display of the plurality of keys (operation S35) and displays the selected character string in the character input area 17A (operation S36).

Subsequently, an area other than the character input area 17A in the touch panel 17 is tapped on (operation S37), and the processor 19 causes the character input mode to transition to the normal mode (operation S38).

The information processing device 1 displays, on the touch panel, first characters assigned to keys near input positions and updates the first characters with second characters assigned to, among a plurality of keys whose display positions are changed by a key change operation, keys near the input positions. Therefore, the motion in which the user of the information processing device places a finger on any one of a plurality of keys while being aware of the display position of the key may be excluded. In the information processing device 1, character input may be performed without imposing, on the user, a burden of placing their finger at the display position of a key.

The information processing device 1 accepts a key change operation in a state in which input position markers for visualizing input positions are displayed on the touch panel 17. Therefore, in the information processing device 1, the user of the information processing device 1 is able to cause the display position of a desired key to approach the input position while referring to the input position markers. This may lead to increased efficiency in character input.

The information processing device 1 displays, on the touch panel, a first character string obtained by sequentially acquiring a plurality of input positions and arranging, in the input order, first characters assigned to keys respectively near the plurality of input positions. The information processing device 1 updates the first character string with a second character string obtained by arranging, in the input order, second characters assigned to keys respectively near a plurality of input positions, out of a plurality of keys whose display positions have been changed by a key change operation. Therefore, in the information processing device 1, a character string may be input without imposing, on a user, the burden of placing the finger at the display position of a key.

When a plurality of character strings are obtained, the information processing device 1 displays a plurality of character strings on the touch panel 17 in a display manner that a second character string for which the sum of distances between a plurality of input positions and keys respectively near the plurality of input positions is smaller is more preferentially selected. Therefore, in the information processing device 1, the burden that is imposed on the user of the information processing device 1 when the user selects a desired character string from a plurality of character strings may be reduced.

When a hover-in state is detected and a key change operation is not accepted, the information processing device 1 displays a plurality of keys at display positions determined using a hover position. When a hover-in state is detected and a kay change operation is accepted, the information processing device 1 displays a plurality of keys at display positions changed by a key change operation. Therefore, in the information processing device 1, a plurality of keys may be displayed at display positions that are very convenient for the user of the information processing device 1.

The information processing device 1 stops display of a plurality of keys when a hover-out state is detected and input positions are not acquired. Therefore, in the information processing device 1, display of a plurality of keys may be automatically stopped when character input is not performed.

All or part of components illustrated in the drawings may be functionally or physically distributed or integrated in arbitrary units in accordance with various kinds of load, the usage state, and the like.

All or any part of various processing functions performed in each device may be executed on a central processing unit (CPU) or on a micro computer such as a micro processing unit (MPU) or a micro controller unit (MCU). All or any part of various processing functions may be performed on a program analyzed and executed by a CPU or a micro computer such as an MPU or an MCU or on hardware using wired logic.

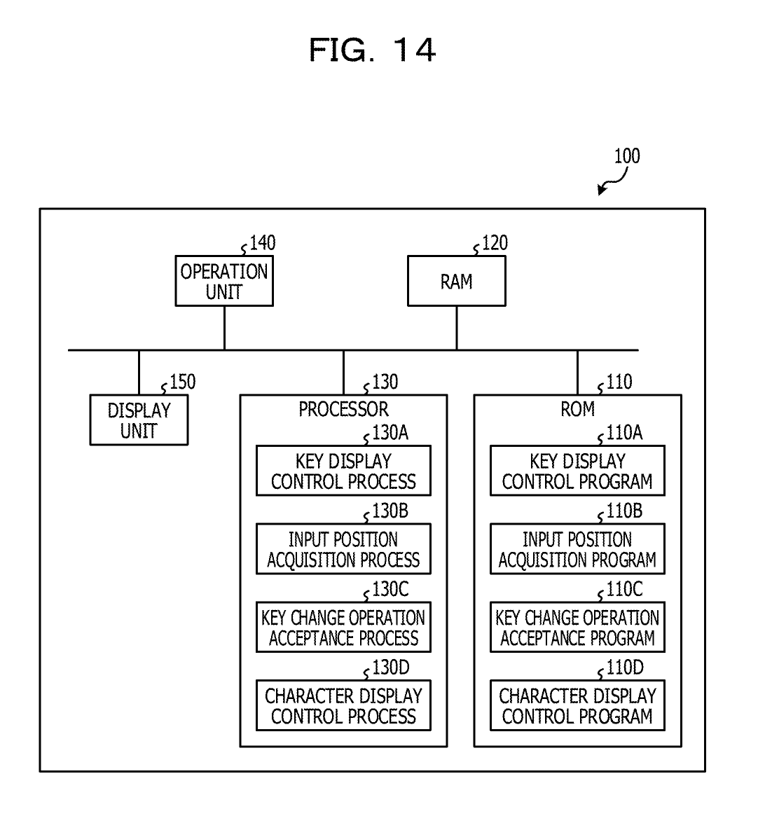

The various kinds of processing described above may be performed by executing a program provided in advance by an information processing device. FIG. 14 illustrates an example of an information processing device.

An information processing device 100 that executes an information processing program illustrated in FIG. 14 includes a ROM 110, a RAM 120, a processor 130, an operation unit 140, and a display unit 150. The operation unit 140 and the display unit 150 may correspond to a touch panel.

In the ROM 110, an operation control program that exerts the functions mentioned above is stored in advance. For example, the information processing program may be stored on a drive-readable recording medium. The recording medium may be, for example, a portable recording medium such as a compact disc ROM (CD-ROM), a digital versatile display (DVD) disc, a universal serial bus (USB) memory, or a secure digital (SD) card, or a semiconductor memory such as a flash memory. The information processing program may include, for example, as illustrated in FIG. 14, a key display control program 110A, an input position acquisition program 1106, a key change operation acceptance program 110C, and a character display control program 110D. The programs 110A, 1106, 110C, and 110D may be integrated or distributed as appropriate.

For example, the processor 130 reads the programs 110A, 1106, 110C, and 110D from the ROM 110 and performs each of the read programs. As illustrated in FIG. 14, the programs 110A, 1106, 110C, and 110D may function as a key display control process 130A, an input position acquisition process 130B, a key change operation acceptance process 130C, and a character display control process 130D. The processes 130A to 130D may correspond to the key display control unit 93, the input position acquisition unit 94, the key change operation acceptance unit 95, and the character display control unit 96 illustrated in FIG. 5.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing device comprising,
a processor configured to execute a program read from a storage device,
wherein the processor, based on the program, performs operations to:
display, on a touch panel, first keys each having a first display position of a character;
acquire a first input position for the touch panel;
display, on the touch panel, a first character assigned to a first proximate key near the first input position, among the first keys; and
update the first character displayed on the touch panel by using a second character assigned to a second proximate key near the first input position, among second keys each having a second display position of the character.

2. The information processing device according to claim 1,
wherein the second keys are obtained based on an operation of changing the first display position of the first keys.

3. The information processing device according to claim 1,
wherein the processor is configured to display an input position marker for the first input position on the touch panel.

4. The information processing device according to claim 3,
wherein the processor is configured to accept a key change operation that accepts an operation of changing the first display position to the second display position in a state in which the first input position marker is displayed on the touch panel.

5. The information processing device according to claim 1,
wherein the processor is configured to:
sequentially acquire a second input position for the touch panel, and
display, on the touch panel, a first character string obtained by arranging the first character and a third character assigned to a third proximate key near the second input position in an order in which the first input position and the second input position are acquired.

6. The information processing device according to claim 5,
wherein the processor is configured to:
update the first character string displayed on the touch panel by using a second character string obtained by arranging, in the order, the second character and a fourth character assigned to a fourth proximate key near the second input position, among the second keys.

7. The information processing device according to claim 6,
wherein, when a multitude of the first character strings are obtained, a first character string for which a sum of a distance between the first input position and the first proximate key and a distance between the second input position and the third proximate key is small is selected and displayed on the touch panel.

8. The information processing device according to claim 1,
wherein the processor configured to:
detect a hover-in state in which a finger of a user using the information processing device is near the touch panel.

9. The information processing device according to claim 8,
wherein the processor configured to:
display, when the hover-in state is detected and an operation of changing the first display position to the second display position is not accepted, the first keys at the first display position based on a position of the finger on the touch panel.

10. The information processing device according to claim 8,
wherein the processor configured to:
display, when the hover-in state is detected and an operation of changing the first display position to the second display position is accepted, the second keys at the second display position.

11. The information processing device according to claim 1,
wherein the processor configured to:
detect a hover-out state in which the finger is away from the touch panel.

12. The information processing device according to claim 11,
wherein the processor configured to:
stop, when the hover-out state is detected and the first input position is not acquired, display of the first keys.

13. An information processing method, comprising:
displaying, on a touch panel, first keys each having a first display position of a character by an information processing device;
acquiring a first input position for the touch panel;
displaying, on the touch panel, a first character assigned to a first key near the first input position among the first keys;
accepting an operation of changing the first display position to a second display position; and
updating the first character displayed on the touch panel by using a second character assigned to a second key near the first input position among second keys each having the second display position.

14. The information processing method according to claim 13, further comprising:
displaying an input position marker for the first input position on the touch panel.

15. The information processing method according to claim 13,
wherein the accepting is performed in a state in which the first input position marker is displayed on the touch panel.

16. The information processing method according to claim 13, further comprising:
acquiring sequentially a second input position for the touch panel; and
displaying, on the touch panel, a first character string obtained by arranging the first character and a third character assigned to a third proximate key near the second input position in an order in which the first input position and the second input position are acquired.

17. An information processing system comprising:
a memory configured to store a program; and
a processor configured to execute the program,
wherein the processor:,
displays first keys each having a first display position of a character;
acquires a first input position for the touch panel;
displays, on the touch panel, a first character assigned to a first proximate key near the first input position among the first keys; and
updates the first character displayed on the touch panel by using a second character assigned to a second proximate key near the first input position among second keys each having a second display position of the character.

18. The information processing system according to claim 17,
wherein the second keys are obtained based on an operation of changing the first display position of the first keys.

19. The information processing system according to claim 17,
wherein the processor is configured to display an input position marker for the first input position on the touch panel.

20. The information processing system according to claim 17,
wherein the processor is configured to accept a key change operation that accepts an operation of changing the first display position to the second display position in a state in which the first input position marker is displayed on the touch panel.
